(19) United States
(12) Patent Application Publication
(10) Pub. No.: US 2006/0236821 A1
(43) Pub. Date: Oct. 26, 2006

(54) Pivotal tool device having crossing arms

(76) Inventor: Chiu Chun Liao, Taichung (TW)

Correspondence Address: CHARLES E. BAXLEY, ESQ., 90 JOHN STREET, THIRD FLOOR, NEW YORK, NY, 10038, US

(21) Appl. No.: 11/099,836

(22) Filed: Apr. 5, 2005

(51) Int. Cl. B25B 13/00; B25B 23/16; B25G 1/00

(52) U.S. Cl. 81/124.4; 81/177.9; 81/177.1; 81/177.2; 81/177.85

(57) ABSTRACT

A pivotal tool device includes two arms each having two driving tool members disposed on the ends. One of the arms includes a shank extended from a middle portion, and the other arm includes a chamber formed in the middle portion, for selectively receiving the shank, to allow the arms to be solidly engaged with each other, and to have a greatly increased driving torque formed between the arms. The shank includes a non-circular cross section for engaging with the non-circular chamber of the other arm. A detent may selectively anchor the arms together. A spring element may selectively bias the arms away from each other.

### BACKGROUND OF THE INVENTION

1. Field of the Invention

The present invention relates to a pivotal tool device, and more particularly to a pivotal tool device having two arms selectively arranged to a crossing structure for working purposes, and to a parallel position for storing purposes.

2. Description of the Prior Art

Typical pivotal tool devices comprise two arms selectively arranged to a crossing structure for working purposes, and selectively arranged to a parallel position for storing purposes, and a latch pin or a latch collar slidably engaged between the two arms, for selectively coupling the two arms together, and for selectively releasing the arms when the latch pin or the latch collar is disengaged from one of the two arms.

For example, U.S. Pat. No. 6,257,103 to Yu, and U.S. Pat. No. 6,692,178 to Yu disclose two of the typical pivotal tool devices, each also comprise two arms selectively arranged to a crossing structure for working purposes, and selectively arranged to a parallel position for storing purposes.

For example, U.S. Pat. No. 6,257,103 to Yu includes a latch pin slidably engaged in one of the arms, and selectively engageable into the other arm, for selectively securing or coupling or latching the two arms together. However, the latch pin includes a relatively smaller diameter and is weak or includes a relatively decreased strength, such that the driving torque between the two arms is greatly decreased.

U.S. Pat. No. 6,692,178 to Yu includes a latch collar slidably engaged in one of the arms, and having two lugs selectively engageable into the other arm, for selectively securing or coupling or latching the two arms together. However, the lugs of the latch collar are also weak, and the driving torque between the two arms is also not good enough for forcefully driving fasteners or other tool members.

The present invention has arisen to mitigate and/or obviate the afore-described disadvantages of the conventional pivotal tool devices.

### SUMMARY OF THE INVENTION

The primary objective of the present invention is to provide a pivotal tool device including two arms selectively arranged to a crossing structure for working purposes, and selectively arranged to a parallel position for storing purposes.

The other objective of the present invention is to provide a pivotal tool device including two arms solidly engageable with each other to have a greatly increased driving torque between the two arms.

In accordance with one aspect of the invention, there is provided a pivotal tool device comprising a first arm including two ends each having a driving tool member provided thereon, and including a middle portion having a shank extended therefrom, and a second arm including two ends each having a driving tool member provided thereon, and including a middle portion having a chamber formed therein, for selectively receiving the shank of the first arm, to allow the arms to be solidly engaged with each other, and to have a greatly increased driving torque provided between the first and the second arms.

The shank includes a non-circular cross section having at least three flat surfaces formed therein, and the second arm includes at least three flat surfaces formed in the middle portion thereof, to define the chamber thereof, and for selectively engaging with the flat surfaces of the shank of the first arm, and thus for allowing the two arms to be solidly engaged or coupled with each other, and for allowing the driving torque between the two arms to be greatly increased.

The shank includes at least one passage formed therein to receive a detent therein, the detent is movable out of the shank, for engaging with the second arm, and for anchoring the second arm to the first arm. The shank includes a bore formed therein to receive a rod therein, the rod is engageable with the detent, to force the detent to move out of the shank, and to selectively engage with the second arm.

The rod includes a peripheral groove formed therein for selectively receiving the detent, and for allowing the detent to be selectively disengaged from the second arm. The shank includes a spring member engaged in the bore thereof, and engaged with the rod, for biasing and disengaging the peripheral groove of the rod away from the detent.

The rod includes an extension extended therefrom and having an outer diameter smaller than that of the rod, to form a peripheral shoulder between the rod and the extension, a cap is secured onto the shank and includes an orifice having an inner diameter smaller than that of the bore of the arm, to slidably receive the reduced extension of the rod, and for engaging with the rod, in order to limit the rod to move relative to the shank, and to prevent the rod from being disengaged from the shank.

The rod includes a knob secured onto the extension thereof, for moving the rod relative to the shank. The second arm includes at least one depression formed therein, for selectively receiving the detent therein.

A spring element may further be provided and disposed between the first and the second arms, for selectively biasing and separating the first and the second arms away from each other. The first arm includes a peripheral slot formed therein, for partially receiving the spring element, the spring element is extendible out of the first arm, and engageable with the second arm, for biasing and separating the first and the second arms away from each other, such as when the detent is disengaged from the second arm.

The shank includes an inclined peripheral surface formed on top thereof, for guiding the shank to engage into the chamber of the second arm, and for allowing second arm to be easily and quickly engaged onto the first arm.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a pivotal tool device in accordance with the present invention;

FIG. 2 is a perspective view of the pivotal tool device;

FIG. 3 is a top plan view of the pivotal tool device which is arranged in a folding position;

FIG. 4 is a partial cross sectional view of the pivotal tool device, taken along lines 4-4 of FIG. 2;

FIG. 5 is a partial cross sectional view of the pivotal tool device, taken along lines 5-5 of FIG. 4; and

FIGS. 6, 7 are partial cross sectional views similar to FIG. 4, illustrating the operation of the pivotal tool device.

### DETAILED DESCRIPTION OF THE PREFERRED EMBODIMENT

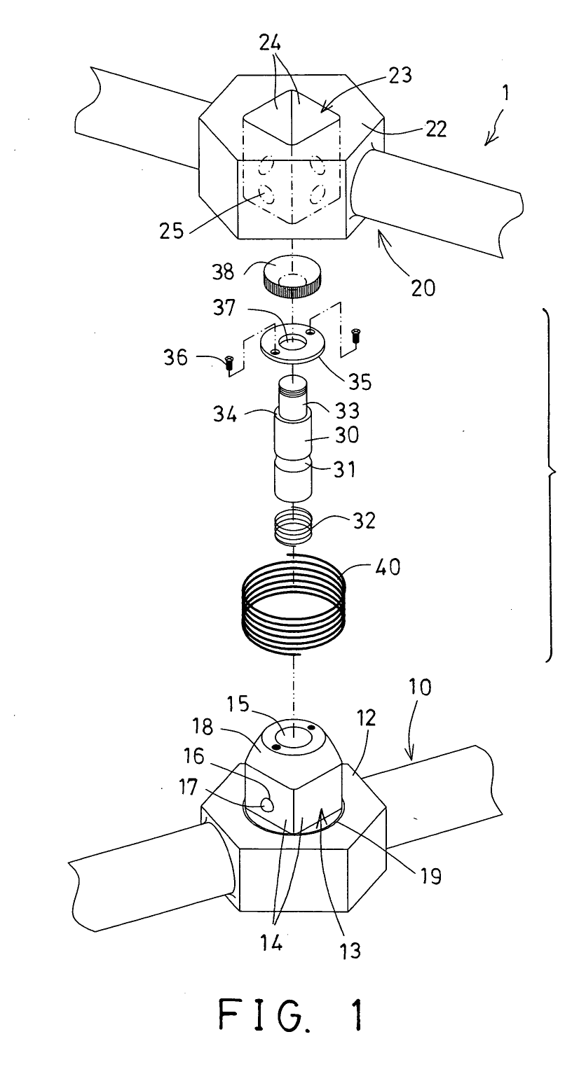

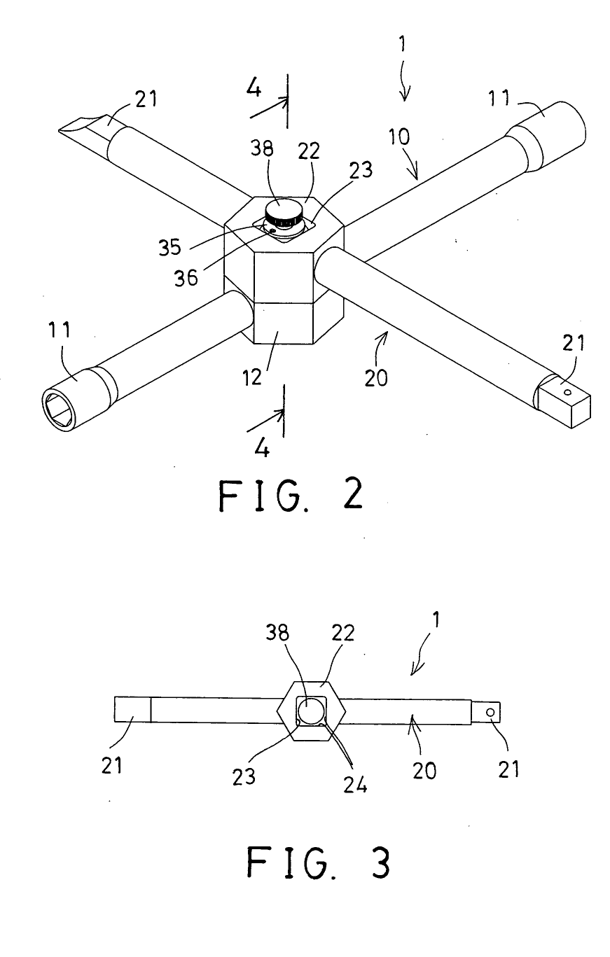

Referring to the drawings, and initially to FIGS. 1 and 2, a pivotal tool device 1 in accordance with the present invention comprises two arms 10, 20 each including two ends each having a driving tool member 11, 21 formed or provided thereon, such as a socket 11, a driving stem 21, a crowbar 21, or other driving tool members, for driving fasteners, took extensions, or other tool elements, etc.

Each of the arms 10, 20 includes an enlarged block 12, 22 formed or provided in the middle portion thereof. One of the arms 10 includes a shank 13 extended upwardly from the block 12 thereof, and preferably having a non-circular cross section, such as a cubic cross section, a rectangular cross section, an octagonal cross section, etc., and having three or more flat surfaces 14 formed in the outer peripheral portion thereof (FIG. 1).

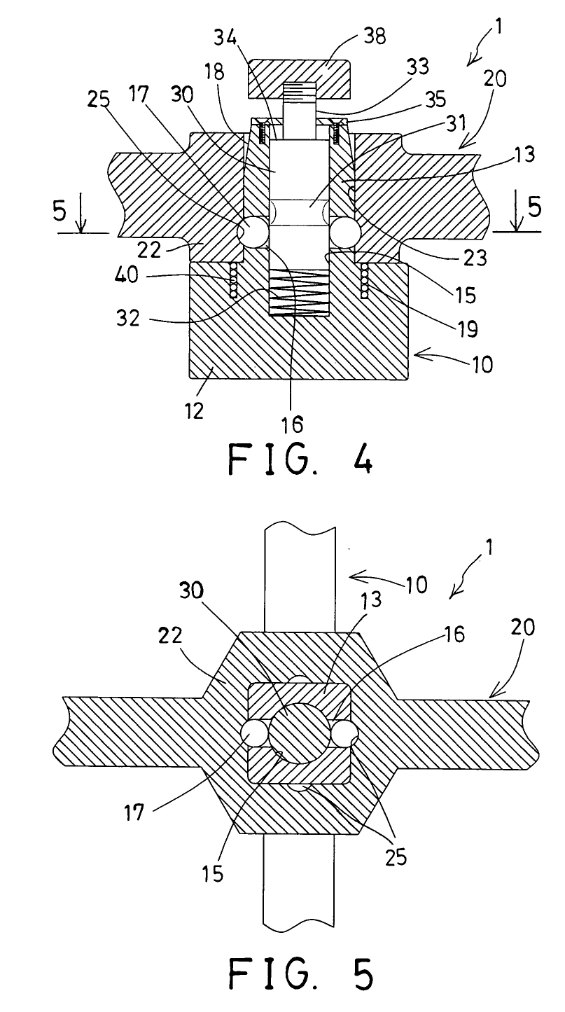

The arm 10 also includes a bore 15 formed therein, which is also formed in or formed through the shank 13 thereof, for slidably receiving a rod 30 therein; and further includes one or more, such as two passages 16 formed therein, and aligned with each other, or oppositely formed on both sides of the bore 15 thereof (FIGS. 4-7) and communicating with the bore 15 thereof, each for slidably receiving a ball or a detent 17 therein which is engageable out of the shank 13 (FIGS. 4, 5).

The block 22 of the other arm 20 includes a chamber 23 formed therein and defined by three or more inner flat surfaces 24 (FIG. 1), for receiving the shank 13 of the arm 10, and for engaging with the corresponding outer flat surfaces 14 of the arm 10, to allow the arms 10, 20 to be solidly engaged with each other, and to have a greatly increased driving torque formed or provided between the two arms 10, 20.

The other arm 20 includes one or more depressions 25 formed in the block 22 thereof, for selectively receiving the ball or detent 17 therein (FIGS. 4, 5) which may be used to secure or to anchor or to position the blocks 12, 22 of the arms 10, 20 together, and thus to prevent the blocks 12, 22 of the arms 10, 20 from being separated from each other. For example, the ball or detent 17 may be forced to engage into the depressions 25 of the block 22 of the arms 20 by the rod 30.

The rod 30 includes a peripheral groove 31 formed in the outer peripheral portion thereof, to selectively receive the ball or detent 17, and thus to allow the ball or detent 17 to be disengaged from the block 22 of the arms 20 (FIG. 6), and thus to allow the block 22 of the arms 20 to be moved or disengaged from the block 12 of the other arm 10, and thus to allow the arms 10, 20 to be separated from each other, or to be rotated relative to each other, to either a crossing structure (FIG. 2) for working purposes, or a parallel position (FIG. 3) for storing purposes.

It is preferable that the shank 13 of the arm 10 includes a rounded or inclined peripheral surface 18 formed in the upper portion thereof, for guiding the shank 13 of the arm 10 to engage into the chamber 23 of the block 22 of the other arm 20, and thus for allowing the block 22 of the other arm 20 to be easily and quickly engaged onto the block 12 of the arm 10.

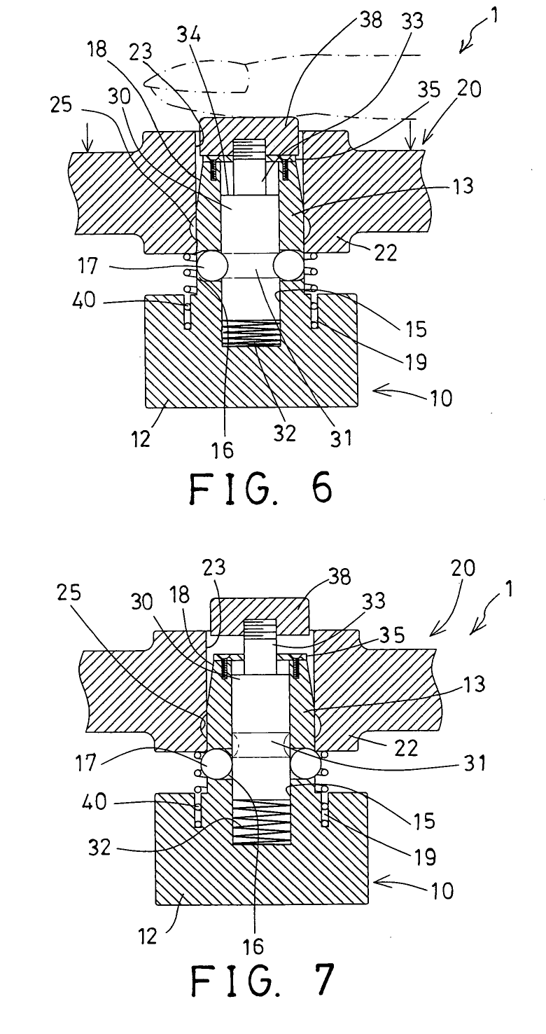

A spring member 32 is also received in the chamber 23 of the block 22 of the other arm 20, and engaged with the rod 30, for biasing the rod 30 to move in a directly outwardly relative to the bore 15 of the arm 10 (FIGS. 4, 7), and for disengaging the peripheral groove 31 of the rod 30 from the ball or detent 17, and thus for allowing the rod 30 to engage with and to force the ball or detent 17 to move partially out of the passages 16 of the shank 13, and/or to engage into the depressions 25 of the block 22 of the arms 20 (FIGS. 4, 5), in order to lock the blocks 12, 22 of the arms 10, 20 together.

The rod 30 includes an extension 33 of a reduced outer diameter extended from the upper portion thereof, and having the outer diameter smaller than that of the rod 30, to form a peripheral shoulder 34 between the rod 30 and the extension 33. A cap 35 is secured onto the shank 13 with one or more fasteners 36, and includes an orifice 37 having an inner diameter smaller than that of the bore 15 of the arm 10, for slidably receiving the reduced extension 33 of the rod 30, and for engaging with the rod 30, in order to limit the rod 30 to move relative to the shank 13, and thus to prevent the rod 30 from being disengaged or separated from the shank 13.

A knob 38 may be attached or secured on top of the reduced extension 33 of the rod 30, for moving the rod 30 against the spring member 32, for example. The knob 38, as shown in the drawing figures, includes an outer diameter smaller than that of the shank 13 or smaller than the inner diameter of the chamber 23 of the block 22 of the other arm 20, to allow the block 22 to be moved beyond the knob 38 and to be moved or disengaged from the block 12 of the other arm 10.

However, the knob 38 may also include an outer diameter greater than that of the shank 13 or greater than the inner diameter of the chamber 23 of the block 22 of the other arm 20, for engaging with the block 22, in order to limit the block 22 to move relative to the other block 12 of the other arm 10, and to prevent the block 22 from being disengaged from the other block 12 of the other arm 10, unless the knob 38 is unthreaded or released or detached from the rod 30.

It is preferable that the block 12 of the arm 10 further includes a peripheral slot 19 formed therein, for partially receiving a spring element 40 which is extendible out of the block 12, and which is engageable with the block 22 of the other arm 20, for biasing or for moving or for separating the block 22 away from the block 12, and thus for biasing or for separating the arms 10, 20 away from each other, particularly when the ball or detent 17 is moved or engaged into the peripheral groove 31 of the rod 30, and when the ball or detent 17 is disengaged from the depressions 25 of the block 22 of the arms 20.

In operation, as shown in FIGS. 2, 4, 5, the shank 13 of the arm 10 may be engaged into the chamber 23 of the block 22 of the other arm 20, and the flat surfaces 14 of the arm 10 may be engaged with the flat surfaces 24 of the other arm 20, to allow the arms 10, 20 to be solidly engaged with each other, and to allow the arms 10, 20 to be rotated or driven by the other with a greatly increased driving torque.

When the rod 30 is depressed into the bore 15 of the arm 10 against the spring member 32, the peripheral groove 31 of the rod 30 may be moved to be aligned with the ball or detent 17, and to allow the ball or detent 17 to be engaged into the peripheral groove 31 of the rod 30 (FIG. 6), and thus to allow the ball or detent 17 to be disengaged from the depressions 25 of the block 22 of the arms 20. At this moment, the spring element 40 may bias and move the block 22 away from the block 12, to separate the arms 10, 20 away from each other.

The arms 10, 20 may thus be separated from each other, and may be rotated relative to each other, to either a crossing structure (FIG. 2) for working purposes, or a parallel position (FIG. 3) for storing purposes. The block 22 may be engaged onto the block 12 again when the rod 30 is depressed against the spring member 32 again to align the peripheral groove 31 of the rod 30 with the ball or detent 17, and to receive the ball or detent 17 therein (FIG. 6), and thus to allow the shank 13 of the arm 10 to be engaged into the chamber 23 of the block 22 of the other arm 20 again, and to allow the arms 10, 20 to be rotated or driven by each other.

Accordingly, the pivotal tool device in accordance with the present invention includes two arms selectively arranged to a crossing structure for working purposes, and selectively arranged to a parallel position for storing purposes, and to have a greatly increased driving torque between the two arms.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pivotal tool device comprising:
a first arm including two ends each having a driving tool member provided thereon, and including a middle portion having a shank extended therefrom, and said shank including a non-circular cross section having at least three flat surfaces formed therein, and
a second arm including two ends each having a driving tool member provided thereon, and including a middle portion having a chamber formed therein and defined by at least three flat surfaces, for selectively receiving said shank of said first arm, to allow said arms to be solidly engaged with each other, and
said at least three flat surfaces of said second arm being selectively engageable with said at least three flat surfaces of said first arm, to greatly increase a driving torque between said first and said second arms.

2. The pivotal tool device as claimed in claim 1, wherein and shank includes at least one passage formed therein to receive a detent therein, said detent is movable out of said shank, for engaging with said second arm, and for anchoring said second arm to said first arm.

3. The pivotal tool device as claimed in claim 2, wherein said shank includes a bore formed therein to receive a rod therein, said rod is engageable with said detent, to force said detent to move out of said shank, and to selectively engage with said second arm.

4. The pivotal tool device as claimed in claim 3, wherein said rod includes a peripheral groove formed therein for selectively receiving said detent, and for allowing said detent to be selectively disengaged from said second arm.

5. The pivotal tool device as claimed in claim 4, wherein said shank includes a spring member engaged in said bore thereof, and engaged with said rod, for biasing and disengaging said peripheral groove of said rod away from said detent.

6. The pivotal tool device as claimed in claim 3, wherein said rod includes an extension extended therefrom and having an outer diameter smaller than that of said rod, to form a peripheral shoulder between said rod and said extension, a cap is secured onto said shank and includes an orifice having an inner diameter smaller than that of said bore of said arm, to slidably receive said reduced extension of said rod, and for engaging with said rod, in order to limit said rod to move relative to said shank, and to prevent said rod from being disengaged from said shank.

7. The pivotal tool device as claimed in claim 6, wherein said rod includes a knob secured onto said extension thereof, for moving said rod relative to said shank.

8. The pivotal tool device as claimed in claim 2, wherein said second arm includes at least one depression formed therein, for selectively receiving said detent therein.

9. The pivotal tool device as claimed in claim 1 further comprising a spring element disposed between said first and said second arms, for selectively biasing and separating said first and said second arms away from each other.

10. The pivotal tool device as claimed in claim 9, wherein said first arm includes a peripheral slot formed therein, for partially receiving said spring element, said spring element is extendible out of said first arm, and is engageable with said second arm, for selectively biasing and separating said first and said second arms away from each other.

11. The pivotal tool device as claimed in claim 1, wherein said shank includes an inclined peripheral surface formed on top thereof, for guiding said shank to engage into said chamber of said second arm, and for allowing second arm to be easily and quickly engaged onto said first arm.
